(19) United States
(12) Patent Application Publication
(10) Pub. No.: US 2009/0102867 A1
(43) Pub. Date: Apr. 23, 2009

(54) DISPLAY METHOD

(75) Inventors: Chia-Cheng Lai, Tainan County (TW); Cheng-Hung Wu, Tainan County (TW); Kuan-Hsu Fan-Chiang, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HIMAX DISPLAY, INC., Tainan County (TW)

(21) Appl. No.: 11/875,951

(22) Filed: Oct. 21, 2007

(51) Int. Cl. G09G 5/00

(52) U.S. Cl. 345/691

(57) ABSTRACT

A display method for a color sequential display to display a frame in a frame time is provided. The frame time includes a first sub-frame time and a second sub-frame time, and the frame includes a first sub-frame and a second sub-frame. The display method includes displaying the first sub-frame in the first sub-frame time which is divided into a first liquid crystal (LC) response time and a first optical display time. In addition, the second sub-frame is displayed in the second sub-frame time which is divided into a second LC response time and a second optical display time. The scales of the first sub-frame time and the second sub-frame time are different from each other according to a default value. The display method improves the optical performance of the color sequential display.

### BACKGROUND OF THE INVENTION

1. Field of the Invention

The present invention relates to a display method. More particularly, the present invention relates to a display method for a color sequential display.

2. Description of Related Art

In recent years, along with the maturation of photoelectric technology and semiconductor manufacturing technology, flat panel displays are developed rapidly. Liquid crystal displays (LCD) advantageous in low-voltage operation, no-radiation, light weight, and small volume have gradually replaces conventional cathode-ray tube displays to become mainstream display products in the market.

An LCD is mainly constituted by an LC panel and a backlight module. As liquid crystals injected into the LC panel do not emit light by themselves, the LC panel must be lightened by a plane light source provided by the backlight module, so as to enable the LCD to display.

The color mixture of color display can be divided into temporal color mixture and spatial color mixture. Currently, the spatial color mixture is generally adopted by displays. For example, in a thin film transistor LCD (TFT-LCD), each display pixel is composed of three pixels, namely, red, green, and blue (RGB) pixels, distributed on the color filter. When the sub-pixels are smaller beyond a distinguishable viewing field of the human eyes, the effect of color mixture can be perceived by human.

In a color sequential method (i.e., the temporal color mixture principle is adopted), each frame is composed of three (for example, RGB) or more monochrome sub-frames. The human eyes can perceive a full-color image by rapidly showing the sub-frames in sequence.

FIG. 1 is a time distribution diagram of a frame according to a conventional display method. Referring to FIG. 1, the conventional display method is suitable for a color sequential display to display a frame in a frame time 110. The frame time 110 is composed of a first sub-frame time 112, a second sub-frame time 114, and a third sub-frame time 116 of the same scale. In addition, the first sub-frame time 112 is composed of an liquid crystal response time (LC response time) 112a and an optical display time 112b, the second sub-frame time 114 is composed of an LC response time 114a and an optical display time 114b, and the third sub-frame time 116 is composed of an LC response time 116a and an optical display time 116b.

The above display method uses a red signal, a green signal, and a blue signal respectively to drive the color sequential display in the first sub-frame time 112, the second sub-frame time 114, and the third sub-frame time 116, so as to enable the color sequential display to display a red frame, a green frame, and a blue frame respectively in the optical display times 112b, 114b, 116b.

In general, the red frame, the green frame, and the blue frame have different maximum brightness. In order to make the frame displayed by the color sequential display reach a preset white balance, the following two methods are employed in the conventional art.

1. The brightness of one of the red, green, and blue frames in the optical display times 112b, 114b, 116b is adjusted to the maximum, and the brightness of the rest are reduced to achieve the white balance.

2. Under the circumstance that the scales of the first sub-frame time 112, the second sub-frame time 114, and the third sub-frame time 116 are identical, the scale of one of the optical display times 112b, 114b, and 116b is adjusted to the maximum, and the scales of the rest are reduced to attenuate light quantity to achieve the white balance.

However, in the first method, as being limited by the attenuated brightness of a part of frames, the light source cannot exert its optimal performance. In the second method, as some optical display times are scaled down, the light generated by the light source cannot be utilized sometimes in the corresponding sub-frame times. Therefore, no matter the first or the second method is adopted to achieve the white balance, the use efficiency of the light source is reduced, and the brightness of the frame is lowered, and thus the optical performance of the color sequential display is limited.

### SUMMARY OF THE INVENTION

A display method is provided to enhance an optical performance of the color sequential display.

A display method for a color sequential display to display a frame in a frame time is provided. The frame time includes a first sub-frame time and a second sub-frame time, and the frame includes a first sub-frame and a second sub-frame. The display method includes displaying the first sub-frame in the first sub-frame time which is divided into a first LC response time and a first optical display time. In addition, the second sub-frame is displayed in the second sub-frame time which is divided into a second LC response time and a second optical display time. The scales of the first sub-frame time and the second sub-frame time are different from each other according to a default value.

A display method for a color sequential display to display a frame in a frame time is also provided. The frame time includes a first sub-frame time, a second sub-frame time, and a third sub-frame time. The display method includes first providing a color temperature value. Then, a first color signal, a second color signal, and a third color signal of the frame are used to drive the color sequential display in the first sub-frame time, the second sub-frame time, and the third sub-frame time, respectively. The scales of the first sub-frame time and the second sub-frame time are different from each other according to the color temperature value.

A display method for a color sequential display to display a frame in a frame time is provided as well. The frame time includes a first sub-frame time, a second sub-frame time, and a third sub-frame time, and the frame includes a first sub-frame, a second sub-frame, and a third sub-frame. The display method includes first providing a color temperature value. Then, the scales of the first sub-frame time, the second sub-frame time, and the third sub-frame time are adjusted according to the color temperature value. The first sub-frame time is divided into a first LC response time and a first optical display time, the second sub-frame time is divided into a second LC response time and a second optical display time, and the third sub-frame time is divided into a third LC response time and a third optical display time. Furthermore, the first sub-frame is displayed in the first sub-frame time, the second sub-frame is displayed in the second sub-frame time, and the third sub-frame is displayed in the third sub-frame time. In addition, the color temperature of the frame meets the color temperature value.

The following embodiments are applicable to the above three display methods.

In an embodiment of the present invention, the color temperature value can be used to achieve the white balance of the frame.

In the display method of the present invention, as the scales of the sub-frame times in a frame time are different from each other according to a default value (for example, color temperature value), the present invention can achieve the white balance of the frame without sacrificing the use efficiency of the light source, thereby improving the optical performance of the color sequential display.

In order to make the aforementioned features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a time distribution diagram of a frame according to a conventional display method.

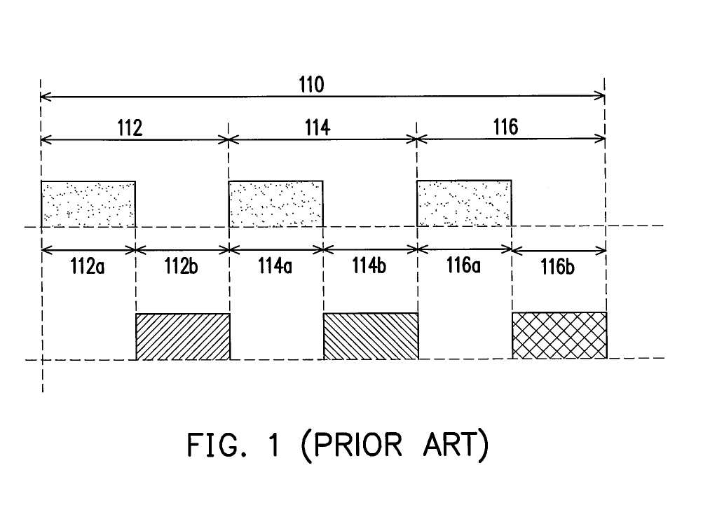

FIG. 2 is a time distribution diagram of a display frame in a display method according to a first embodiment of the present invention.

FIG. 3 is a schematic view of points in the CIE 1931 chromaticity diagram corresponding to lights of different colors.

FIG. 4 is a time distribution diagram of a display frame in a display method according to a second embodiment of the present invention.

### DESCRIPTION OF EMBODIMENTS

### The First Embodiment

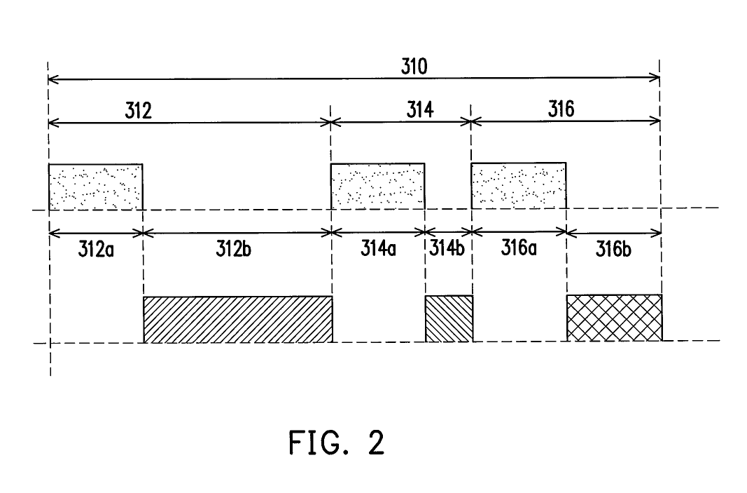

FIG. 2 is a time distribution diagram of a display frame in a display method according to a first embodiment of the present invention. Referring to FIG. 2, the display method in this embodiment is used to display a frame in a frame time 310. The frame time 310 may include a first sub-frame time 312, a second sub-frame time 314, and a third sub-frame time 316, and the frame may include a first sub-frame, a second sub-frame, and a third sub-frame.

The display method of this embodiment includes follow steps. A first sub-frame is displayed in the sub-frame time 312 which is divided into an LC response time 312a and an optical display time 312b. A second sub-frame is displayed in the second sub-frame time 314 which is divided into an LC response time 314a and an optical display time 314b. A third sub-frame is displayed in the third sub-frame time 316 which is divided into an LC response time 316a and an optical display time 316b. The LC response times 312a, 314a, and 316a are the time duration that LC molecules in the color sequential display are deflected to a preset angle when sensing the changes of the electric field. The optical display times 312b, 314b, and 316b are the time duration that the light source of the color sequential display emits light and the light passes through the LC molecules to display an image.

In this embodiment, the scales of the first sub-frame time 312 and the second sub-frame time 314 are different from each other according to a default value. Similarly, the optical display time 312b and the optical display time 314b are also different from each other according to the default value. The default value is, for example, a color temperature value, which is used to achieve the white balance of the frame. The color temperature value is, for example, preset before the color sequential display is delivered from the factory, or can be set by a user through a menu of the frame. The details of the implementation are described as follows.

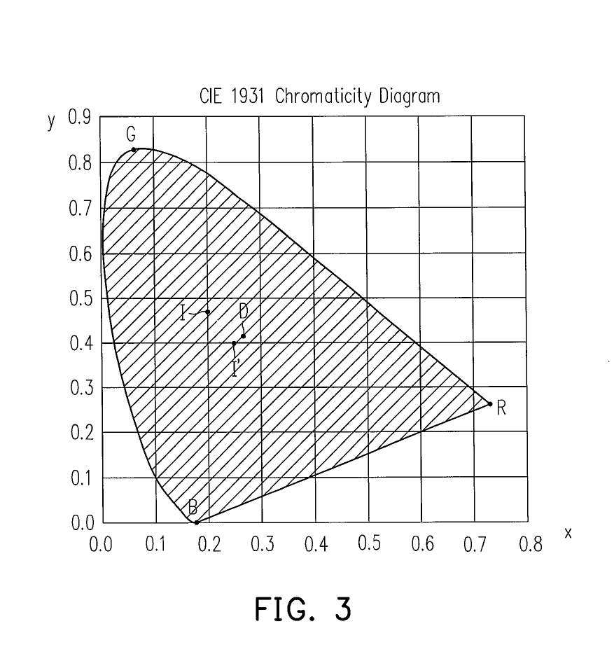

The first sub-frame, the second sub-frame, and the third sub-frame respectively display a first color data, a second color data, and a third color data of the frame, in which the first, second, and third color data are, for example, red, green, and blue data respectively. When the color sequential display displays the first, second, or the third sub-frame, the light source may emit a light of a first, second, or third color, for example, a red, green, or blue light, respectively. Then, the lights of these colors respectively pass through the LC molecules in the optical display time 312b, 314b, or 316b to exhibit the red, green, and blue data. FIG. 3 is a schematic view of points in the CIE 1931 chromaticity diagram corresponding to lights of different colors. Referring to FIGS. 2 and 3, the positions of points R, G, and B in FIG. 3 respectively represent the color coordinates of the pure red, green, and blue lights emitted by the light source of the color sequential display. The position of the point I represents, for example, the color coordinate of the white color before adjusting the frame to achieve the white balance, and the position of the point D is a preset color coordinate. Compared with the preset color coordinate, the white color presented by the frame is slightly green.

The display method in this embodiment may be used to solve the above problem of the slightly green of the white color. Referring to FIG. 2, the first optical display time 312b (the first sub-frame time 312) may be enlarged, and the second optical display time 314b (the second sub-frame time 314) may be reduced, so as to prolong the time for the first sub-frame displaying the red data and shorten the time for the second sub-frame displaying the green data. Therefore, in the frame, the color coordinate point I of a white color originally exhibited by the frame will shift towards the red and blue colors to reach the point I′. The point I′ is close to or overlapped with the preset color coordinate point D, so as to achieve an appropriate white balance. However, the display method in the present invention is not limited to solve the above problem of slightly green of the white color, but can also be used to solve the problem of white shifting into any color by the use of the same principle, thereby achieving an appropriate white balance.

In the display method of this embodiment, the scales of the sub-frame times 312, 314, and 316 for displaying various sub-frames in a frame time 310 are different from each other according to a default value (for example, color temperature value). Thus, after the scales of some optical display times are adjusted by the display method in this embodiment, the scales of the corresponding sub-frame times are also adjusted. In the conventional art, as the sub-frame times of fixed scales are adopted, in order to achieve the white balance of the frame, the intensities of the lights of some colors emitted by the light source must be adjusted or the light source must be turned off in some time beyond the LC response time. Compared with the conventional art, the display adopting the display method in this embodiment provides a high brightness without sacrificing the use efficiency of the light source, and achieves the white balance of the frame. As such, the display method in this embodiment can utilize the brightness of the light source sufficiently to improve the optical performance of the color sequential display.

It should be noted that the sequence of the first, second, and third sub-frame times 312, 314, and 316 is not limited in the present invention. Besides the sequence as shown in FIG. 2, other sequences can also be adopted. Moreover, the display method in the present invention is not limited to make the scales of the first sub-frame time 312 and the second sub-frame time 314 different from each other according to a default value, and can also make the scales of the second sub-frame time 314 and the third sub-frame time 316 different from each other, or make the scales of the first sub-frame time 312 and the third sub-frame time 316 different from each other, or make the scales of the first sub-frame time 312, the second sub-frame time 314, and the third sub-frame time 316 different from one another. Further, the scales of the LC response times 312a, 314a, and 316a can be the same. In addition, the present invention does not limit the first, second, and third color data to be RGB data, and the color data can be, for example, YUV color difference data.

The display method according to another embodiment of the present invention is similar to the aforementioned display method, and the differences between the two are mentioned below. The display method in this embodiment provides a color temperature value firstly. Then, the scales of the first sub-frame time 312, the second sub-frame time 314, and the third sub-frame time 316 are adjusted according to the color temperature value, so as to make the color temperature of the frame (i.e., the display frame) meet the color temperature value. In particular, the scales of the optical display times 312b, 314b, and 316b can be adjusted to make the color temperature of the frame (i.e., the display frame) meet the color temperature value.

The display method according to still another embodiment of the present invention is similar to the above display method, and the differences between the two are mentioned below. The display method in this embodiment provides a color temperature value firstly. Then, a first color signal, a second color signal, and a third color signal of the frame (i.e., the display frame) are used to drive the color sequential display in the first sub-frame time 312, the second sub-frame time 314, and the third sub-frame time 316, respectively. The scales of the first sub-frame time 312 and the second sub-frame time 314 are different from each other according to the color temperature value. For example, the scales of the first sub-frame time 312 and the second sub-frame time 314 are different from each other according to the color temperature value. In addition, the scales of the LC response time 312a and the LC response time 314a can be identical.

In this embodiment, the first color signal, the second color signal, and the third color signal are, for example, RGB signals or YUV signals. The above three display methods have similar advantages and performances, and the details will not be described herein again.

### The Second Embodiment

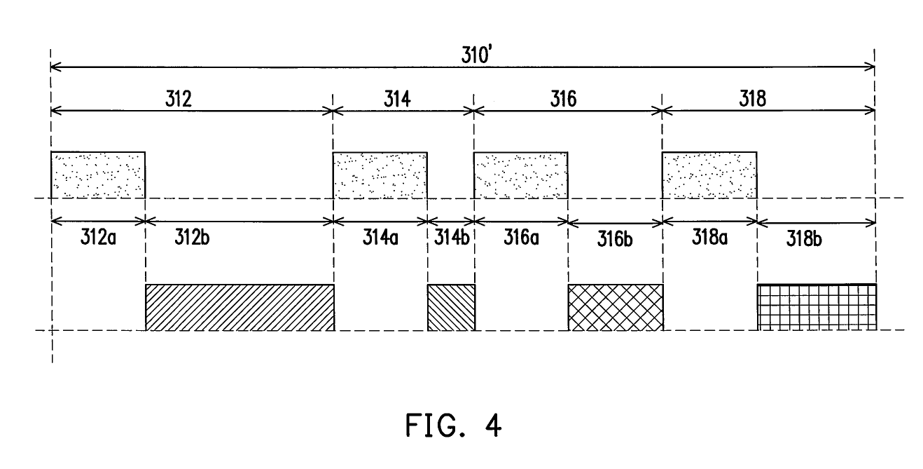

FIG. 4 is a time distribution diagram of a display frame in a display method according to a second embodiment of the present invention. Referring to FIG. 4, the display method in this embodiment is similar to the display method in the first embodiment, and the differences between the two are mentioned below. In the display method of this embodiment, the frame time 310′ further includes a fourth sub-frame time 318, and the display method in this embodiment may further comprise using a fourth color signal of the frame to drive the color sequential display in the fourth sub-frame time 318.

In this embodiment, the scales of the first sub-frame time 312 and the second sub-frame time 314 can be different from each other according to the color temperature value, and the scales of any three sub-frame times or all of the first to the fourth sub-frame times 312-318 can also be different from one another. In detail, the fourth sub-frame time 318 may be divided into an LC response time 318a and an optical display time 318b, and in this embodiment, the scales of the optical display times 312b, 314b, 316b, and 318b are different from one another according to the color temperature value. Further, in this embodiment, the first color signal, the second color signal, the third color signal, and the fourth color signal are, for example, red, green, blue and white (RGBW) signals or other suitable signals.

It should be noted that, the present invention does not limit the number of the sub-frame times contained in a frame time to be three or four. In other embodiments, the sub-frame times contained in a frame time can be any appropriate number.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A display method, for a color sequential display to display a frame in a frame time, wherein the frame time comprises a first sub-frame time and a second sub-frame time, and the frame comprises a first sub-frame and a second sub-frame, the display method comprising:
displaying the first sub-frame in the first sub-frame time, wherein the first sub-frame time is divided into a first liquid crystal (LC) response time and a first optical display time; and
displaying the second sub-frame in the second sub-frame time, wherein the second sub-frame time is divided into a second LC response time and a second optical display time,
wherein the scales of the first sub-frame time and the second sub-frame time are different from each other according to a default value.

2. The display method as claimed in claim 1, wherein the scales of the first optical display time and the second optical display time are different from each other according to the default value.

3. The display method as claimed in claim 1, wherein the default value is a color temperature value.

4. The display method as claimed in claim 1, wherein the default value is used to achieve a white balance of the frame.

5. The display method as claimed in claim 1, wherein the scales of the first LC response time and the second LC response time are identical.

6. A display method, for a color sequential display to display a frame in a frame time, wherein the frame time comprises a first sub-frame time, a second sub-frame time, and a third sub-frame time, the display method comprising:
providing a color temperature value; and
using a first color signal, a second color signal, and a third color signal of the frame to drive the color sequential display in the first sub-frame time, the second sub-frame time, and the third sub-frame time, respectively,
wherein the scales of the first sub-frame time and the second sub-frame time are different from each other according to the color temperature value.

7. The display method as claimed in claim 6, wherein each sub-frame time is divided into an LC response time and an optical display time.

8. The display method as claimed in claim 7, wherein the scales of the optical display time of the first sub-frame time and the optical display time of the second sub-frame time are different from each other according to the color temperature value.

9. The display method as claimed in claim 7, wherein the scales of the LC response time of the first sub-frame time and the LC response time of the second sub-frame time are identical.

10. The display method as claimed in claim 6, wherein the color temperature value is used to achieve a white balance of the frame.

11. The display method as claimed in claim 6, wherein the first color signal, the second color signal, and the third color signal are YUV signals.

12. The display method as claimed in claim 6, wherein the first color signal, the second color signal, and the third color signal are RGB signals.

13. The display method as claimed in claim 6, wherein the frame time further comprises a fourth sub-frame time, and the display method further comprises using a fourth color signal of the frame to drive the color sequential display in the fourth sub-frame time.

14. The display method as claimed in claim 13, wherein the scales of the first sub-frame time, the second sub-frame time, and the third sub-frame time are different from each other according to the color temperature value.

15. The display method as claimed in claim 13, wherein the first color signal, the second color signal, the third color signal, and the fourth color signal are RGBW signals.

16. A display method, for a color sequential display to display a frame in a frame time, wherein the frame time comprises a first sub-frame time, a second sub-frame time, and a third sub-frame time, and the frame comprises a first sub-frame, a second sub-frame, and a third sub-frame, the display method comprising:
providing a color temperature value;
adjusting the scales of the first sub-frame time, the second sub-frame time, and the third sub-frame time according to the color temperature value, wherein the first sub-frame time is divided into a first LC response time and a first optical display time, the second sub-frame time is divided into a second LC response time and a second optical display time, and the third sub-frame time is divided into a third LC response time and a third optical display time;
displaying the first sub-frame in the first sub-frame time;
displaying the second sub-frame in the second sub-frame time; and
displaying the third sub-frame in the third sub-frame time,
wherein the color temperature of the frame meets the color temperature value.

17. The display method as claimed in claim 16, further comprising adjusting the scales of the first optical display time, the second optical display time, and the third optical display time to make the color temperature of the frame meet the color temperature value.

18. The display method as claimed in claim 16, wherein the color temperature value is used to achieve a white balance of the frame.

19. The display method as claimed in claim 16, wherein the first sub-frame, the second sub-frame, and the third sub-frame display a first color data, a second color data, and a third color data of the frame, respectively.

20. The display method as claimed in claim 19, wherein the first color data, the second color data, and the third color data are YUV data.

21. The display method as claimed in claim 19, wherein the first color data, the second color data, and the third color data are RGB data.
